(19) United States
(12) Patent Application Publication
(10) Pub. No.: US 2025/0303603 A1
(43) Pub. Date: Oct. 2, 2025

(54) METHOD FOR ATTACHING BLADE MEMBER, AND BLADE MEMBER ATTACHMENT JIG

(71) Applicant: FURUKAWA ELECTRIC CO., LTD., Tokyo (JP)

(72) Inventors: Akihiro Komatsuzaki, Tokyo (JP); Tomohiro Akiyama, Tokyo (JP)

(21) Appl. No.: 19/237,326

(22) Filed: Jun. 13, 2025

Related U.S. Application Data
(63) Continuation of application No. PCT/JP2023/045962, filed on Dec. 21, 2023.

(30) Foreign Application Priority Data
Dec. 27, 2022 (JP) 2022-209910

(51) Int. Cl. B26D 7/26; B26D 1/15; G02B 6/25

(52) U.S. Cl. CPC B26D 7/2621; B26D 1/15; G02B 6/25

(57) ABSTRACT

A shaft part of a disk-shaped blade member has a support part that supports the blade member and a fixing screw that fixes the support part, and the blade member is arranged so as to be interposed between the fixing screw and the support part. A pin oriented in the direction perpendicular to the axial direction of the shaft part is formed in the support part (shaft part). A jig is a member used when attaching the blade member to a cutting device. A hole is formed in a substantially cylindrical body of the jig. The pin provided to the shaft part of the blade member is insertable in the hole. Through use of the jig, by mounting the jig on the pin and using the jig to attach the blade member to a blade member attachment part, it is possible to attach the blade member to the attachment part without touching the blade member.

### TECHNICAL FIELD

The present invention relates to a method for attaching a blade member to a cutting device for cutting an optical fiber, and a blade member attachment jig.

### BACKGROUND OF THE INVENTION

When an optical fiber is to be fusion spliced, conventionally, coating of an optical fiber core is removed first and then the optical fiber is cut into predetermined size. As a cutting device for cutting the optical fiber, there has been a device that removes the coating of the optical fiber core to expose a glass fiber portion and scratches a surface of the glass fiber portion by contacting a disc-shaped blade member to cut the optical fiber.

However, in the above-mentioned cutting device, the blade member may be deteriorated due to repeated contact with the optical fiber. Thus, a device in which a contact position with the optical fiber can be replaced by rotating the blade member during cutting operation has been proposed.

As such the cutting device, Japanese Unexamined Patent Application Publication No. 2008-203815 (JP-A-2008-203815), for example, has proposed a device in which a contact position with the optical fiber can be replaced by rotating the blade member in conjunction with movement of the disc-shaped blade member during cutting operation.

Here, if a rotational axis of the circular blade member is at a perfect center of the blade member, the position of the blade member does not change even when the blade member is rotated. Thus, even if the blade member is rotated in use, relative relationship thereof with the optical fiber can always be kept constant and a consistent scratch can be made to the optical fiber.

However, because of manufacturing accuracy of the blade member or the like, the rotational axis of the blade member may become off-center and eccentric. In such the case, if the blade member is rotated in use, the position of the blade member changes due to the rotation of the blade member. This changes depth of the scratch made to the optical fiber. If the scratch depth changes in this way, it becomes difficult to cut the optical fiber with high precision, thereby deteriorating cutting quality of the optical fiber.

In contrast, Japanese Unexamined Patent Application Publication No. 2018-163195 (JP-A-2018-163195) has proposed a cutting device in which the blade member can be positioned at proximity of a blade tip of the blade member by bringing a tapered-shaped positioning portion into contact with a tapered portion of the disc-shaped blade member. According to JP-A-2018-163195, a blade-tip position of the blade member can be restricted with higher precision even when the rotational axis of the blade member is eccentric.

When the blade member is to be rotated in use and an entire circumference of the blade member is used up, the blade member is to be replaced by a new one. However, since the blade member is a small part, handling thereof is not so easy. In addition, if the blade member is to be attached to the positioning portion as mentioned above, operability is particularly poor.

### SUMMARY OF THE INVENTION

The present invention was made in view of the above-mentioned problems. It is an object of the present invention to provide a blade-member attachment jig that facilitates replacement of a blade member, and a method for attaching the blade member using the jig.

To achieve the above object, a first aspect of the present invention is a method for attaching a blade member in a cutting device for cutting an optical fiber. The method includes having a pin formed in a direction perpendicular to an axial direction of a shaft part of the disc-shaped blade member, and using a jig having a hole into which the pin can be inserted, fitting the jig to the pin, and attaching the blade member to an attachment part of the blade member using the jig.

The shaft part may include a support part for supporting the blade member and a fixing member for fixing the support part. The support part and the fixing member may be disposed so as to interpose the blade member. An elastic member may be disposed between the fixing member and the blade member. The elastic member may press the blade member toward the support part. The pin may be disposed on the support part, and when the jig is fitted, the blade member may be pushed back toward the elastic member so as to widen a gap between the support part and the blade member, allowing the attachment part to be inserted into the gap so as to attach the blade member to the attachment part.

A push-out rod may be inserted from one side of the hole of the jig, and the pin may be inserted into the other side of the hole. After attaching the blade member to the attachment part, the jig may be detached from the pin by pushing in the push-out rod.

The jig may include a finger hook protruding from a side surface in proximity of an end portion on an insertion side of the push-out rod, and a finger may be hooked on the finger hook to push in the push-out rod.

According to the first aspect of the present invention, by fitting the jig to the pin attached to the blade member, even a small blade member can be handled using the jig, thereby facilitating replacement of the blade member.

In particular, if the cutting device has a structure in which the blade member is pressed to the support part for supporting the blade member, it is difficult to insert the attachment part into the gap between the blade member and the support part. However, if the jig can widen the gap into which the attachment part can be inserted, operability for attaching the blade member can be improved.

Also, if the push-out rod is inserted from the one side of the jig, it is easy to detach the jig from the blade member after attaching the blade member to the attachment part.

Furthermore, by providing the finger hook on the jig, the push-out rod can be pushed in while hooking a finger, which facilitates pushing operation of the push-out rod.

A second aspect of the present invention is a jig used for attaching a blade member to a cutting device for cutting an optical fiber. The blade member has a disc shape, and includes a pin that is formed in a direction perpendicular to an axial direction of a shaft part. The jig includes a substantially cylindrical-shaped main body having a hole through which the pin can be inserted or removed, and the jig allows the blade member to be attached to an attachment object with the pin being inserted into the hole.

With a push-out rod being inserted from one side of the hole and the pin being inserted from the other side of the hole, the jig may be detached from the pin by pushing in the push-out rod.

The jig may include a finger hook protruding from a side surface in proximity of an end portion on an insertion side of the push-out rod, and a finger may be hooked on the finger hook to push in the push-out rod so that the jig can be detached from the pin.

According to the second aspect of the present invention, when attaching the blade member to the attachment part, there is no need to hold the blade member itself and this can make the operation safer and easier.

Also, if the push-out rod is inserted from the one side of the jig, it is easy to detach the jig from the blade member once the blade member is attached to the attachment part.

Furthermore, by providing the finger hook on the jig, the push-out rod can be pushed in while hooking a finger, and this can further facilitate the operation.

The present invention can provide a blade-member attachment jig that facilitates replacement of a blade member, and a method for attaching the blade member using the jig.

### BRIEF DESCRIPTION OF DRAWINGS

FIG. 1 is a perspective view showing a cutting device 1.

FIG. 2A is an upper perspective view of a cutting unit 9.

FIG. 2B is a lower perspective view of the cutting unit 9.

FIG. 3A is a perspective view of a back surface side of the cutting unit 9.

FIG. 3B is a plan view of the cutting unit 9.

FIG. 4 is a schematic view showing a positioning mechanism of a blade member 19.

FIG. 5A is an exploded perspective view of the blade member 19 and positioning members 15a and 15b.

FIG. 5B is an enlarged view of a section E in FIG. 5A.

FIG. 6A is a perspective view of the positioning member 15b when the blade member 19 and the positioning members 15a and 15b are assembled.

FIG. 6B is an enlarged view of a section F in FIG. 6A.

FIG. 7A is a perspective view showing a positional relationship between the blade member 19 and projections 35.

FIG. 7B is a plan view showing the positional relationship between the blade member 19 and the projections 35.

FIG. 8A is a view showing the positioning member 15a and 15b.

FIG. 8B is a view showing the blade member 19.

FIG. 9A is a front view of the positioning member 15a.

FIG. 9B is a front view of a support part 25.

FIG. 10A is a view showing a step of attaching a jig 45 to the blade member 19.

FIG. 10B is a view showing a step of attaching the jig 45 to the blade member 19.

FIG. 11A is a view showing a step of attaching the jig 45 to the blade member 19.

FIG. 11B is a view showing a step of attaching the jig 45 to the blade member 19.

FIG. 12 is a view showing a state in which the blade member 19 is attached to the positioning members 15a and 15b.

FIG. 13A is a view showing a step of attaching a jig 45a to the blade member 19.

FIG. 13B is a view showing a step of attaching the jig 45a to the blade member 19.

FIG. 14 is a view showing a step of attaching a jig 45b to the blade member 19.

### DETAILED DESCRIPTION

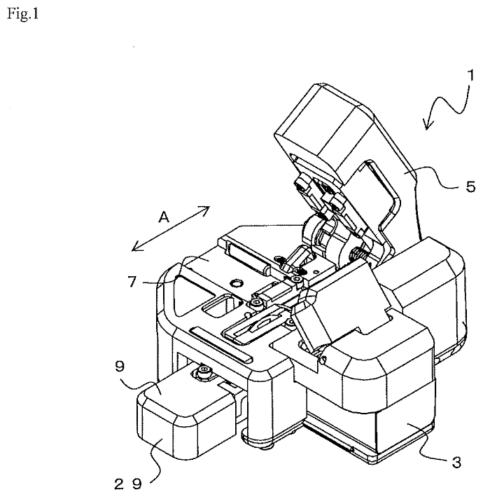

Hereinafter, embodiments of the present invention will be described with reference to the accompanying drawings. FIG. 1 is a perspective view showing a cutting device 1. The cutting device 1 mainly includes a main body 3, a lid portion 5, a cutting unit 9, and so on. The cutting device 1 is a device for cutting an optical fiber at a predetermined position.

A holder-mounting portion 7 is formed on an upper surface of the main body 3. A holder holding the optical fiber is to be mounted on the holder-mounting portion 7. A glass fiber portion that has been exposed by removing a coating of the optical fiber protrudes from an end of the holder. When the holder is disposed on the holder-mounting portion 7, the optical fiber is disposed striding over a moving range of the cutting unit 9.

In a normal state, a handling portion 29 of the cutting unit 9 protrudes from the main body 3. When the handling portion 29 is pushed into the main body 3 from such the state, the cutting unit 9 moves inside the main body 3. At this time, since the cutting unit 9 is pressed in a direction to be pushed out from the main body 3 by an elastic member, the cutting unit 9 is pushed inside the main body 3 against pressing force of the elastic member. When the cutting unit 9 is pushed in completely, a blade tip of the cutting unit 9 moves to a rear side beyond the optical fiber. In such the state, the cutting unit 9 is held by a locking portion, which is not shown in the drawing.

If the lid portion 5 is closed in such the state, the locking portion that has held the cutting unit 9 is released and the above-mentioned elastic member pushes the cutting unit 9 out from the main body 3. That is, the cutting unit 9 moves. That is, the cutting unit 9 is movable in both ways of a direction A in the drawing. When the cutting unit 9 moves, the blade tip comes into contact with the optical fiber, scratching the optical fiber, and the optical fiber can be cut by applying bending stress or the like to the scratched part.

As above, the cutting unit 9 (the handling portion 29) is normally kept protruding from the main body 3 and is pushed into the main body 3 when in use. In this way, the cutting unit 9 can be easily pushed in when the main body 3 is placed on a desk or the like to be operated, for example.

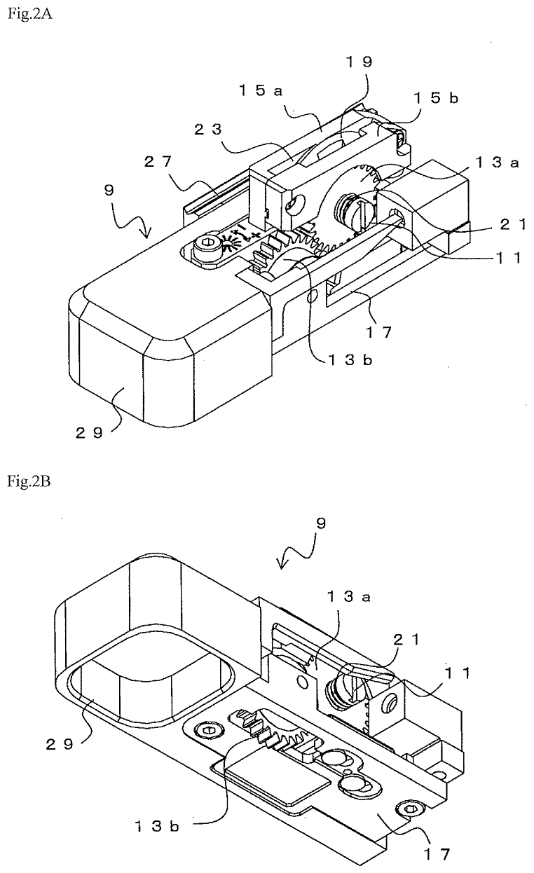

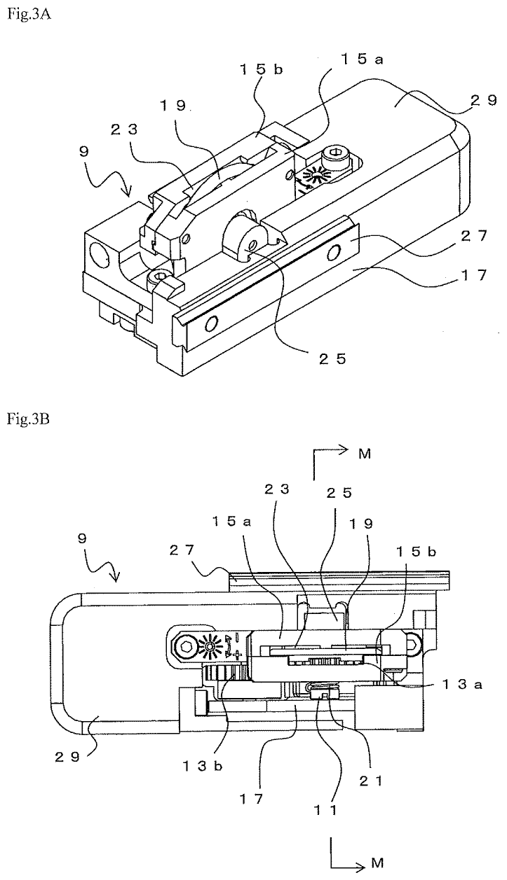

Next, the cutting unit 9 will be described. FIG. 2A is an upper perspective view of the cutting unit 9, FIG. 2B is a lower perspective view of the cutting unit 9, FIG. 3A is a perspective view of a back surface side of the cutting unit 9, and FIG. 3B is a plan view of the cutting unit 9. The cutting unit 9 includes a base 17, a support part 25 (FIG. 3A and FIG. 3B), a blade member 19, positioning members 15a and 15b, and so on.

A rail 27 is fixed on a side surface of the base 17. The rail 27 can slidably move with respect to a slide block (not shown) that is fixed to the main body 3 of the cutting device 1. That is, the cutting unit 9 is movable in the direction A in FIG. 1 with respect to the main body 3.

The blade member 19 is disposed on an upper part of the cutting unit 9. The blade member 19 is a substantially disc-shaped member and a circumferential part thereof serves as a blade tip. The blade member 19 is stored inside the positioning members 15a and 15b. The positioning members 15a and 15b are members for restricting a position of the blade member 19 and are fixed to the base 17. When the positioning members 15a and 15b are brought to face each other and then joined to each other, a slit 23 is formed at an upper part of the positioning members 15a and 15b. A tip of the blade member 19 protrudes from the slit 23 toward a front surface side (upward) of the positioning members 15a and 15b.

A part of an inner edge of the slit 23 comes into contact with the blade member 19. Thus, the positioning members 15a and 15b serve as a positioning portion for restricting the position of the blade member 19. A method for positioning the blade member 19 in the positioning members 15a and 15b will be described in detail below.

A concave portion is formed on a bottom surface side of the handling portion 29. In this way, a user can insert fingers into the concave portion of the handling portion 29 to handle the cutting unit 9.

For example, as mentioned above, the handling portion 29 is normally kept protruding from the main body 3 so that operability is good when the main body 3 is placed on a desk to be operated. On the other hand, when the main body 3 is held in hands to be operated, an end of the handling portion 29 is away from the main body 3, which makes operation difficult for users with small hands. However, providing the concave portion, into which fingers can be inserted, on a back surface of the handling portion 29 makes operability excellent even if the main body 3 is held in hands during the operation.

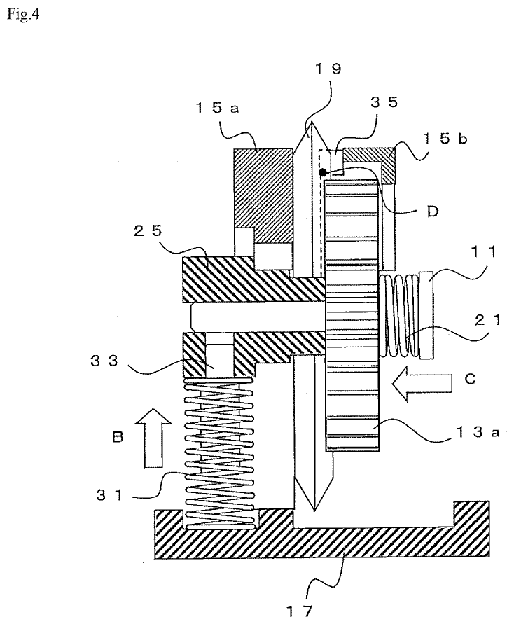

A part of a gear 13b protrudes from a bottom surface side of the cutting unit 9. The gear 13b is an operation unit for rotating the blade member 19. FIG. 4 is a cross-sectional perspective view taken along M-M line in FIG. 3B. A gear 13a is fixed to the blade member 19. The gear 13b meshes with the gear 13a that is fixed to the blade member 19. Thus, rotating the gear 13b can rotate the gear 13a as well as the blade member 19.

As above, the gear 13b can change a circumferential position of the blade member 19 protruding from the slit 23. Thus, it is possible to change the circumferential position of the blade member 19 that comes into contact with the optical fiber. A method for rotating the blade member 19 is not specifically limited to the above. Also, when in use, a stopper, which is not shown, restricts the rotation of the gear 13b and the blade member 19 is fixed at a predetermined circumferential position.

The support part 25 is fixed on one side of the blade member 19. A pin 33 is connected at a lower part of the support part 25. Also, an elastic member 31, which is a first elastic member, is disposed on an outer periphery of the pin 33. The support part 25 is disposed so as to be changeable in height with respect to the base 17 and supports the blade member 19. The elastic member 31 presses the support part 25 upward with respect to the base 17. Since the positioning members 15a and 15b are fixed to the base 17, the blade member 19 fixed to the support part 25 is pressed toward the upper part of the positioning members 15a and 15b (toward the slit 23, i.e. toward the positioning portions) (an arrow B in the drawing).

To adjust a tip position of the blade member 19, heights of the positioning members 15a and 15b with respect to the base 17 may be adjusted. For example, the heights of the positioning members 15a and 15b with respect to the base 17 may be fine-tuned by pushing down the positioning member 15a with a screw provided in a long hole of the positioning member 15a and pushing up the positioning member 15a with a set screw provided in a separately provided screw hole. Thus, the tip position of the blade member 19 with respect to the base 17 can be fine-tuned. The height adjustment for the positioning members 15a and 15b with respect to the base 17 is not always required and, also, another method may be used to adjust the heights of the positioning members 15a and 15b.

At this time, a projection 35 is formed on an inner surface side of the positioning member 15b as a positioning portion for the blade member 19. The blade member 19 is positioned by contacting the projection 35. The positioning of the positioning member 15b by the projection 35 will be described in detail below.

Also, the blade member 19 is disposed so as to be placed between the gear 13a and the support part 25 and is fixed with a fixing screw 11. Also, a part of the positioning member 15a is placed in a gap between the support part 25 and the blade member 19. At this time, an elastic member 21, which is a second elastic member, is disposed in a gap between a head of the fixing screw 11 and the gear 13a (the blade member 19 fixed with the gear 13a).

The elastic member 21 presses the blade member 19 toward the support part 25, in an axial direction of the blade member 19 (the left-right direction in the drawing), and thus the elastic member 21 presses one surface of the blade member 19 (a surface on the left side in the drawing, which is substantially perpendicular to the axial direction except for a tapered portion) against the inner surface of the positioning member 15a (an arrow C in the drawing). Thus, the one surface of the blade member 19 can come into surface-contact with the inner surface of the positioning member 15a that is fixed to the base 17.

By bringing the one surface of the blade member 19 into surface-contact with the inner surface of the positioning member 15a in this way, the position of the blade member 19 in the axial direction (the position in the left-right direction in the drawing) can be positioned with certainty. In addition, since the blade member 19 and the positioning member 15a are pressed against each other through surface-contact, axial misalignment of the blade member 19 (a planar part of the blade member 19 being oriented diagonally with respect to a moving direction (a direction perpendicular to the paper surface) or a height direction of the blade member 19) can be suppressed, and thus the axial direction of the blade member 19 can be maintained perpendicular to either the moving direction and the height direction of the blade member 19.

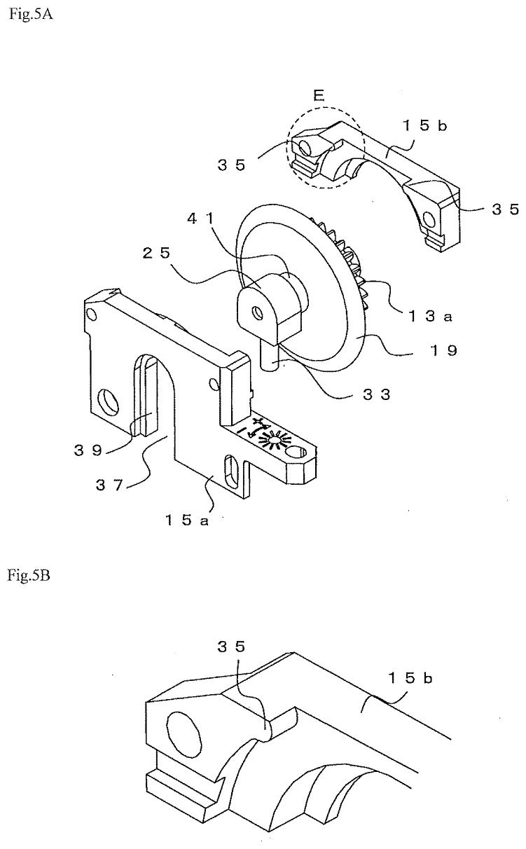

Next, the method for positioning the blade member 19 by the positioning member 15b will be described in detail. FIG. 5A is an exploded perspective view of the positioning members 15a and 15b and the blade member 19. As mentioned above, the inner surface of the positioning member 15a is in surface-contact with the one planar part of the blade member 19. Meanwhile, a pair of the projections 35 are formed at an upper part of the positioning member 15b on a side surface thereof that is opposite to the positioning member 15a.

FIG. 5B is an enlarged view of a section E in FIG. 5A. The projections 35 project toward the inner surface side at the upper part of the positioning member 15b. Thus, when the positioning members 15a and 15b are joined and fixed to each other, the projections 35 are positioned at proximities of both end portions of the slit 23.

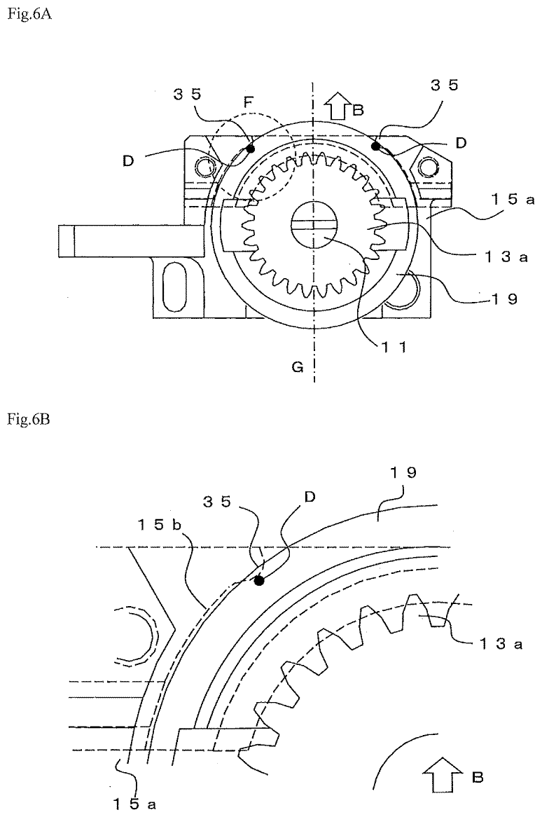

FIG. 6A is a view showing a state in which the blade member 19 is stored inside the positioning members 15a and 15b, and is a perspective view of the positioning member 15b (the positioning member 15b is shown by dotted lines). As shown in FIG. 6A, a pair of the projections 35 projecting to the inner surface side are formed, as the positioning portion for the blade member 19, on one of facing edges of the slit 23 (an edge portion of the inner surface of the positioning member 15b). The projections 35 are formed at two positions with a vertical centerline (axis) of the blade member 19 therebetween.

Also, as mentioned above, the blade member 19 is in a substantially disc shape, and a tapered portion, of which thickness gradually decreases toward the outer periphery, is formed on an outer edge side of the planar part at the center. Thus, when the blade member 19 is pressed upward (a direction of the arrow B in the drawing), the tapered portion of the blade member 19 comes into contact with the projections 35 (a section D in the drawing).

In more detail, a part of the blade member 19 is inserted from a back side of the slit 23, and, with respect to the tapered portions formed on both sides of the blade tip of the blade member 19, one of the tapered portions comes into contact with each of the projections 35 on the inner edge of the slit 23. At this time, the tip of the blade member 19 protrudes toward a front surface side of the slit 23. A method for attaching the blade member 19 to the positioning members 15a and 15b will be described below.

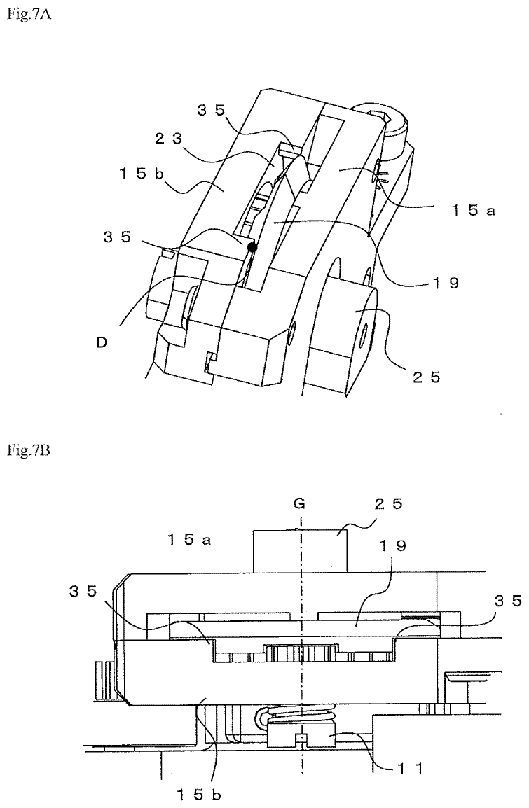

FIG. 6B is an enlarged view of a section F in FIG. 6A. Also, FIG. 7A is an upper perspective view showing a contacting portion between the projections 35 and the blade member 19, and FIG. 7B is an upper plan view of the blade member 19.

As shown in FIG. 6B, when viewed from the axial direction of the blade member 19, tips of the projections 35 (the contacting portions with the blade member 19) are formed arc-shaped. Also, since the tapered portion of the blade member 19 is formed in a circular shape along the outer periphery, the arc portions of the projections 35 are in point-contact with the tapered portion of the blade member 19. That is, the blade member 19 is pressed upward (toward the slit 23) by the elastic member 31, and the tapered portion of the blade member 19 comes into contact with the projections 35, thereby restricting the further upward movement. As a result, the blade member 19 can be positioned in the height direction.

At this time, as shown in FIG. 6A, the pair of projections 35 are disposed at positions symmetrical to a centerline extending in the height direction of the blade member 19 (a vertical centerline passing through the axis, i.e. G in the drawing, for example). That is, the blade member 19 is positioned, with respect to the height direction, at two points when viewed from above. By performing the positioning at the two points of the positions that are predetermined distance away from the centerline (axis) in this way, the blade member 19 can be positioned also with respect to the moving direction (the left-right direction in the drawing).

For example, when the positioning member is brought into surface-contact with the tapered portion of the blade member 19, depending on accuracy of the positioning members 15a and 15b and fixing accuracy, there may be cases where the positioning member does not come into complete surface-contact, but is misaligned and comes into contact at an angle, and this may change the height of the blade tip. Also, even if both the positioning members 15a and 15b are to perform positioning of the blade member in the height direction by point-contact, there may be cases where heights of positioning portions on both sides may not match and, because of the point-contact at one point on each side, the axis of the blade member may be misaligned and the blade member may not be butted perpendicularly against the optical fiber.

In contrast, in the present embodiment, the one surface of the blade member 19 is in surface-contact with the inner surface of the positioning member 15a and, at the same time, the elastic member 31 presses the blade member 19 toward the slit 23 so that the tapered portion on the other surface of the blade member comes into point-contact with the projections 35 and the blade member 19 is positioned. In this way, even if a slight misalignment occurs when joining the positioning members 15a and 15b, the blade member 19 still can be positioned with high precision since only the positioning member 15b performs the positioning of the blade member 19 in the height and moving directions and the positioning member 15a suppresses misalignment (tilting) of the axis of the blade member 19.

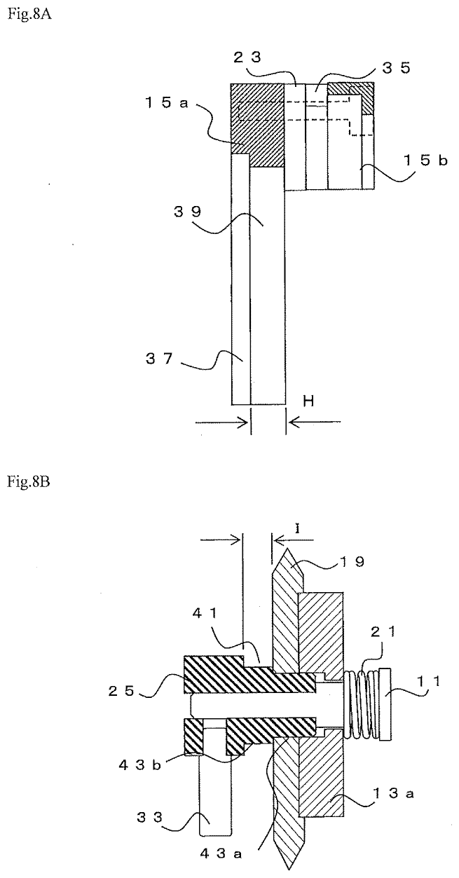

Next, a method for attaching the blade member 19 to the cutting device will be described. FIG. 8A and FIG. 8B are views showing the positioning members 15a and 15b and the blade member 19, respectively. As mentioned above, the slit 23 is formed by joining the positioning members 15a and 15b, and the blade member 19 is inserted from a lower part of the slit 23.

In the descriptions hereinafter, unless otherwise specified, a member formed by joining the positioning member 15a and the positioning member 15b will be described as an object to which the blade member 19 is to be attached. Also, the support part 25 fixed to the axis of the blade member 19 and so on, including the fixing screw 11, will be simply referred to as a shaft part of the blade member 19. That is, the shaft part of the disc-shaped blade member 19 includes the support part 25 for supporting the blade member 19 and the fixing screw 11 for fixing the support part 25, and the blade member 19 is disposed between the fixing screw 11 and the support part 25.

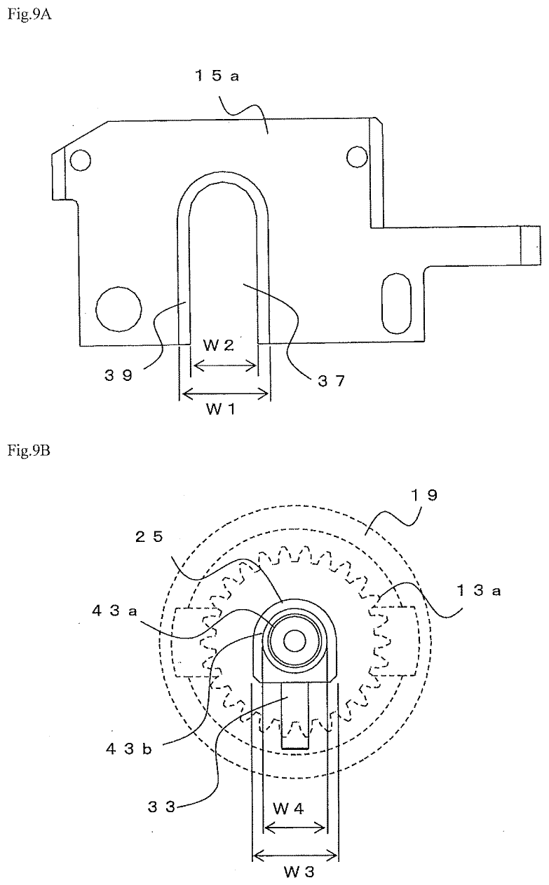

As mentioned above, on the support part 25 (the shaft part), the pin 33 is formed in a direction perpendicular to the axis direction. FIG. 9A is a front view of the positioning member 15a, and FIG. 9B is a view showing the shaft part viewed from a side of a reduced-diameter portion 43a (a perspective view of the blade member 19 etc.). As shown in FIG. 8B and FIG. 9B, the shaft part has the largest width at a part where one end of the pin 33 is fixed (the support part 25) and is provided with, in order toward the other end, a reduced-diameter portion 43b, of which a diameter is reduced by level difference, and the reduced-diameter portion 43a, of which a diameter is further reduced by level difference. The reduced-diameter portion 43a on a tip side with the most reduced diameter is inserted into a hole at the center of the blade member 19.

As mentioned above, the support part 25 is fixed to the blade member 19 with the fixing screw 11. Also, the elastic member 21 is disposed between a head (an enlarged-diameter portion) of the fixing screw 11 and the gear 13a that is fixed to the blade member 19. Although slightly movable between the head of the fixing screw 11 and the support part 25 (a range of the reduced-diameter portion 43a), the blade member 19 is pressed toward the support part 25 (the level difference between the reduced-diameter portions 43a and 43b) by the elastic member 21.

Also, as shown in FIG. 9A, the positioning member 15a includes a cutout portion 37 opening downward, into which the shaft part (the support part 25 and the reduced-diameter portion 43b) of the blade member 19 can be inserted. A convex portion 39 is formed on an inner periphery surface of the cutout portion 37. The convex portion 39 has a relatively small thickness compared to the other parts and protrudes to an inner side of the cutout.

Here, a gap 41 (FIG. 8B) is formed between the blade member 19 and the support part 25. In a normal state, the blade member 19 is pressed against the level difference between the reduced-diameter portions 43a and 43b, and thus a length of the gap 41 (I in the drawing) between the blade member 19 and the support part 25 is equal to a length of the reduced-diameter portion 43b.

Also, when attaching the blade member 19 to a cutting component, the convex portion 39 of the positioning member 15a is inserted into the gap between the blade member 19 and the support part 25. That is, as shown in FIG. 9A and FIG. 9B, a width of the cutout portion 37 (W1 in FIG. 9A) is slightly larger than a width of the support part 25 (W3 in FIG. 9B), and, also, a width at the convex portion 39 (W2 in FIG. 9A) is smaller than the width of the support part 25 (W3 in FIG. 9B) and larger than a width of the reduced-diameter portion 43b (W4 in FIG. 9B).

Also, as shown in FIG. 8A, a thickness at the convex portion 39 (H in the drawing) is larger than the length of the reduced-diameter portion 43b (I in the drawing). For this reason, when attaching the blade member 19 to the cutting component, it is necessary to push back the blade member 19 toward the head of the fixing screw 11 to widen the gap 41. However, since the blade member 19 is a small component, operability thereof is poor.

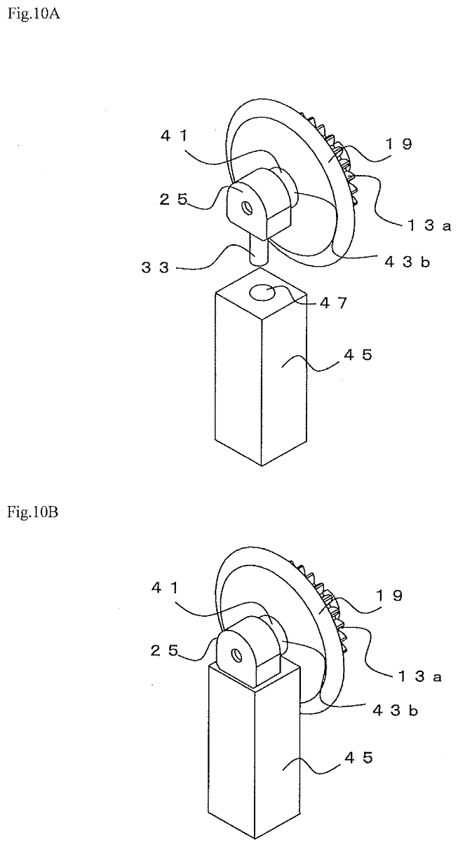

FIG. 10A and FIG. 10B are perspective views showing a method for attaching a jig 45 to the blade member 19. The jig 45 is a blade member attachment member that is used when attaching the blade member 19 to the cutting device. The jig 45 is a member including a substantially cylindrical main body with a hole 47 formed therein. The pin 33 provided on the shaft part of the blade member 19 can be inserted into the hole 47. The hole 47 is formed so as to penetrate the main body in a longitudinal direction thereof. A length of the jig 45 is sufficiently long compared to the pin 33, and a thickness of the jig 45 is sufficiently thick compared to the pin 33. For example, although the length of the pin 33 is set so as not to protrude from the blade member 19 when viewed from the front, by attaching the jig 45, the jig 45 can be protruded to an extent that it can be pinched with fingers when viewed from the front of the blade member 19.

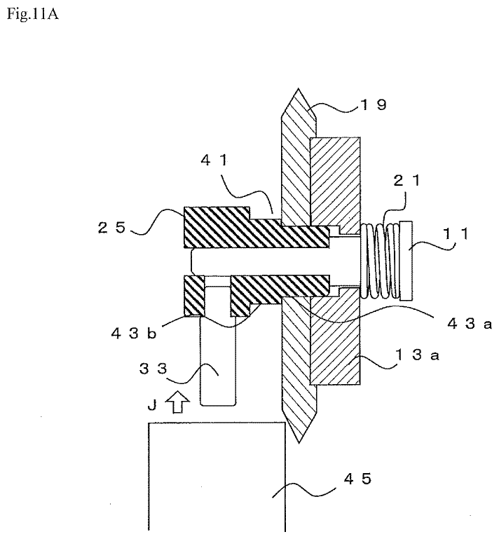

FIG. 11A and FIG. 11B are cross-sectional views at the time of attaching the jig 45 to the blade member 19. As mentioned above, the blade member 19 is pressed against the level difference between the reduced-diameter portions 43a and 43b. In such the state, when the jig 45 is attached to the pin 33 of the blade member as shown in FIG. 11A (an arrow J in the drawing), a part of the jig 45 comes into contact with the blade member 19.

That is, a distance between an inner surface of the hole 47 of the jig 45 and an outer surface of the jig 45 is larger than a distance between the pin 33 and the blade member 19. Thus, as shown in FIG. 11B, when the jig 45 is attached to the blade member 19 (the pin 33), the blade member 19 is pushed back toward the elastic member 21 by the jig 45 (an arrow K in the drawing). That is, when the jig 45 is fitted to the blade member 19, the jig 45 pushes back the blade member 19 to be moved toward the head of the fixing screw 11, thereby widening the gap 41 between the support part 25 and the blade member 19.

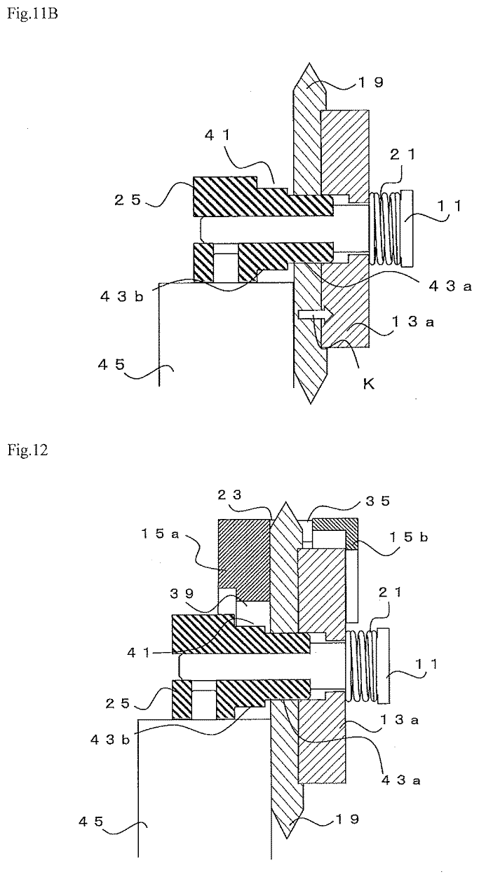

FIG. 12 is a view showing a state in which the blade member 19 is attached in such the state to the positioning members 15a and 15b, which are the attachment object. The jig 45 is used to make the size of the gap 41 between the blade member 19 and the support part 25 larger than the thickness H of the convex portion 39 of the positioning member 15a so that the convex portion 39 can be easily inserted into the gap 41. That is, by inserting the convex portion 39 as an attachment part into the gap 41, the blade member 19 can be attached to the attachment part.

As above, by using the jig 45 having the hole 47 into which the pin 33 can be inserted, fitting the jig 45 to the pin 33, and attaching the blade member 19 to the attachment part of the blade member 19 by using the jig 45, the blade member 19 can be attached to the attachment part without touching the blade member 19. For example, as shown in FIG. 10B, since the jig 45 protrudes from the blade member 19, the jig 45 can be held without touching the blade member 19 with fingers.

The jig 45 to which the blade member 19 is fitted may be held by hand during the operation, or a rod-shaped member such as a driver may be further attached from the opposite side of the hole 47 and the rod-shaped member may be held during the operation. After attaching the blade member 19, the jig 45 is pulled out from the pin 33, thereby completing attachment operation of the blade member 19. When detaching the blade member 19 from the attachment part, the above steps may be carried out in reverse order.

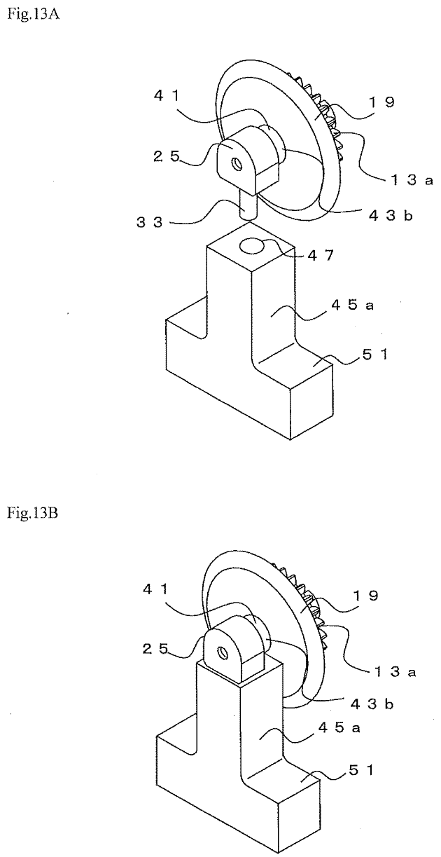

A jig used for attachment operation of the blade member 19 is not limited to the above-mentioned example. FIG. 13A and FIG. 13B are views showing steps of attaching a jig 45a to the blade member 19. The jig 45a has substantially the same structure as the jig 45 except that the jig 45a includes a finger hook 51 being formed. The finger hook 51 is formed so as to protrude from both sides of the main body of the jig 45a. The finger hook 51 is not limited to have a particular shape. The jig 45a can also be used in the similar way as the jig 45. At this time, hooking fingers on the finger hook 51 facilitates handling of the jig 45a.

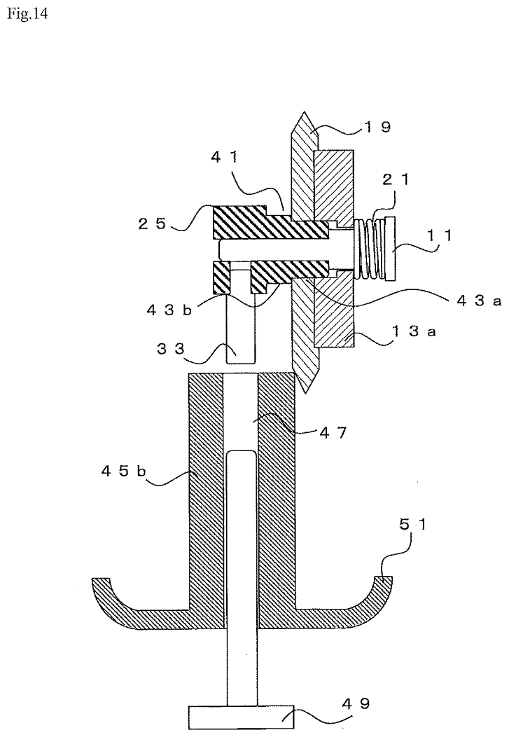

Also, FIG. 14 is a view showing a method for fitting another jig 45b to the blade member 19. The jig 45b has substantially the same structure as the jig 45 except that the jig 45b is provided with a push-out rod 49 and the finger hook 51.

For the jig 45b, the push-out rod 49 is inserted from one side of the hole 47. By inserting the pin 33 from the other side of the hole 47, the jig 45b can be fitted to the blade member 19. After attaching the blade member 19 to the attachment part, the jig 45b can be detached easily from the pin 33 (the blade member 19) by pushing the push-out rod 49 into the main body. Also, similarly to the jig 45a, the jig 45b includes a finger hook 51 protruding from a side surface in proximity of an end portion on the insertion side of the push-out rod 49, and thus hooking fingers on the finger hook 51 when pushing in the push-out rod 49 facilitates the push-in operation of the push-out rod 49. The finger hook 51 is not limited to have a particular shape.

As described above, according to the embodiments of the present invention, by providing the elastic member 31 that presses the blade member 19 to the positioning member 15b, which restricts the height of the blade member 19, the height of the tip of the blade member 19 protruding to the front surface side of the slit 23 can be kept constant even if a rotational axis of the blade member 19 is eccentric. That is, the positional relationship between the optical fiber and the blade tip of the blade member 19 can be kept constant.

Also, the elastic member 21 allows the blade member 19 to come into surface-contact with the inner surface of the positioning member 15a. This can restrict the orientation of the axis of the blade member 19 with certainty. That is, the orientation of the blade portion of the blade member 19 with respect to the optical fiber can be kept constant.

In this way, the blade member 19 can scratch the optical fiber under fixed conditions at all times. As a result, it is possible to suppress occurrence of variation in cross-sectional shapes or poor cutting of the optical fiber caused by variation in the depth of the scratch. Thus, cutting quality of the optical fiber can be improved.

Also, precision in machining the rotational axis of the blade member 19 is not required to be so high, and this facilitates manufacturing of the blade member 19 and cuts down machining cost of the blade member 19.

Also, by using the jig 45, 45a, or 45b for such the blade member 19, replacement of the blade member 19 can be carried out safely and easily. For example, the blade member 19 is small and thus handling thereof is poor, and touching the blade tip is even dangerous. However, by using the jig 45 etc., the blade member can be handled without touching the blade tip, thereby facilitating the operation. Also, as mentioned above, even in the case in which the blade member 19 is pressed toward the support part 25, the jig 45 etc. enables to make the gap 41 wide enough to insert the attachment part (the convex portion 39) and thus the attachment operation is easy.

Also, using the push-out rod 49 facilitates the operation of pulling out the pin 33 from the jig 45b. Furthermore, providing the finger hook 51 facilitates the operation of pushing the push-out rod 49.

Although the embodiments of the present invention have been described referring to the attached drawings, the technical scope of the present invention is not limited to the embodiments described above. It is obvious that persons skilled in the art can think out various examples of changes or modifications within the scope of the technical idea disclosed in the claims, and it will be understood that they naturally belong to the technical scope of the present invention.

For example, in the above-mentioned embodiments, positioning of the blade member 19 is carried out by the positioning members 15a and 15b. However, the jig 45, 45a, and 45b are also applicable to conventional cases in which the blade member is positioned at the axis. That is, if the blade member has a pin in a direction perpendicular to the axis of the blade member, the blade member can be easily replaced by using the jig 45 or the like.

What is claimed is:

1. A method for attaching a blade member in a cutting device for cutting an optical fiber, the method comprising:
having a pin formed in a direction perpendicular to an axial direction of a shaft part of the disc-shaped blade member; and
using a jig having a hole into which the pin can be inserted, fitting the jig to the pin, and attaching the blade member to an attachment part of the blade member by using the jig.

2. The method for attaching the blade member according to claim 1, wherein:
the shaft part includes a support part for supporting the blade member and a fixing member for fixing the support part, and the support part and the fixing member are disposed so as to interpose the blade member;
an elastic member is disposed between the fixing member and the blade member, and the elastic member presses the blade member toward the support part;
the pin is disposed on the support part;
when the jig is fitted, the blade member is pushed back toward the elastic member so as to widen a gap between the support part and the blade member; and
the attachment part is inserted into the gap so as to attach the blade member to the attachment part.

3. The method for attaching the blade member according to claim 1, wherein:
a push-out rod is inserted from one side of the hole of the jig and the pin is inserted into the other side of the hole; and
after attaching the blade member to the attachment part, the jig is detached from the pin by pushing in the push-out rod.

4. The method for attaching the blade member according to claim 3, wherein the jig includes a finger hook protruding from a side surface in proximity of an end portion on an insertion side of the push-out rod, and a finger is hooked on the finger hook to push in the push-out rod.

5. A blade member attachment jig used for attaching a blade member to a cutting device for cutting an optical fiber, wherein:
the blade member is in a disc shape and includes a pin that is formed in a direction perpendicular to an axial direction of a shaft part;
the jig has a substantially cylindrical-shaped main body having a hole through which the pin can be inserted or removed; and
the jig allows the blade member to be attached to an attachment object with the pin being inserted into the hole.

6. The blade member attachment jig according to claim 5, wherein with a push-out rod being inserted from one side of the hole and the pin being inserted from the other side of the hole, the jig can be detached from the pin by pushing in the push-out rod.

7. The blade member attachment jig according to claim 6, wherein the jig includes a finger hook protruding from a side surface in proximity of an end portion on an insertion side of the push-out rod, and a finger can be hooked on the finger hook to push in the push-out rod so that the jig can be detached from the pin.
